(19) United States
(12) Patent Application Publication
(10) Pub. No.: US 2006/0250338 A1
(43) Pub. Date: Nov. 9, 2006

(54) Liquid crystal display device and driving method to avoid disclinations

(76) Inventors: Gerardus Petrus Karman, Eindhoven (NL); Barry Mos, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/567,069

(22) PCT Filed: Jul. 30, 2004
(86) PCT No.: PCT/IB04/51345

§ 371 Date: Feb. 3, 2006

(30) Foreign Application Priority Data
Aug. 6, 2003 (EP) 03102442.5

(51) Int. Cl. G09G 3/36

(52) U.S. Cl. 345/87

(57) ABSTRACT

This invention relates to a liquid crystal display device (1) for avoiding disclinations comprising a first and a second substrate (2 and 3), said first and second substrates (2 and 3) being located facing one another with a liquid crystal material layer (6) thereinbetween, a first and a second electrode (4 and 5) arranged at said first and second substrates (2 and 3) respectively, said first and second electrodes (4 and 5) being formed on the liquid crystal side of the said first and second substrates (2 and 3), whereby the liquid crystal material layer (6) exhibits zero-pretilt and at least one of the electrodes (4 and 5) at its end parts (7, 9; 8, 10) is connected to at least a first and a second mutually different and adjustable voltage sources, so as to develop a voltage gradient across the electrode and is adapted to exhibit an electrical resistance between the end parts (7, 9; 8, 10).

The present invention relates to a liquid crystal display device for avoiding disclinations. The invention also concerns a method of using such a liquid crystal display device.

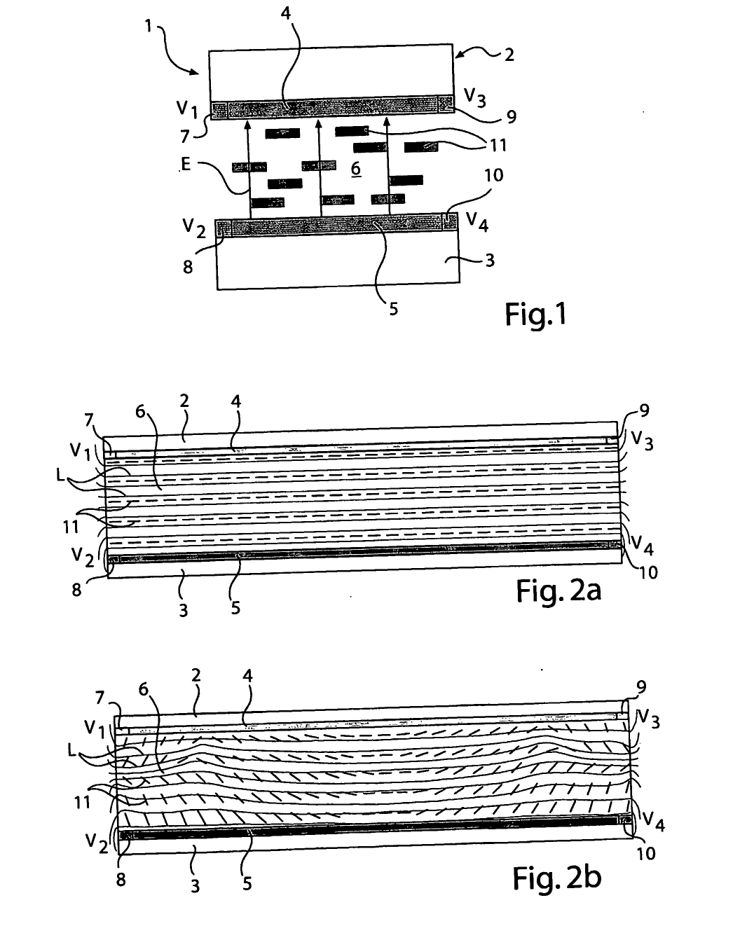

Liquid crystal displays (LCDs) are being used to present all sorts of information and are nowadays amongst the most common types of flat displays. In an LCD an electromagnetic field is used to rotate the liquid crystal (LC) molecules which in turn influences the transmission of light through the display. In this way colored and non-colored areas can be presented on the display. The electromagnetic field is generated by applying voltages to two electrodes each having a separate substrate with a liquid crystal material layer thereinbetween. The principle of operation is schematically illustrated in FIG. 1, where first and a second substrates 2 and 3 are arranged with fully conducting first and second electrodes 4 and 5 respectively. When a voltage difference is applied over said electrodes 4 and 5, an electromagnetic field E is generated between them and the liquid crystal molecules 11 may thus be switched between a relaxed state (e.g. horizontally oriented as shown in FIG. 1) and an affected state (having a different orientation, not shown in FIG. 1).

Although not shown in FIG. 1, on top of the electrodes is a so-called alignment layer arranged in order to give the liquid crystal molecules 11 a common initial orientation (referred to as its “relaxed state” above). The alignment layer can be realized by treating the layer in a variety of contact or non-contact alignment techniques. The latter ones are becoming increasingly important because of several disadvantages with the more conventional contact alignment techniques.

In case the liquid crystal molecules 11 near the surface of the substrates 2 and 3 are oriented perfectly horizontally the applying of the voltage gives rise to a division of the liquid molecular layer 6 into domains with different tilt orientations in relation to the substrate 2 and 3 with boundaries between them. These boundary regions are also referred to as disclinations. The result of these disclinations appearing in zero-pretilt (in this application the term zero-pretilt is defined as a pretilt value so low that disclinations occur during switching) LCDs is a diminished brightness and contrast of the display and also a decrease in switching speed.

The situation is illustrated in FIG. 2a and FIG. 2b, where a simulation of the switching operation is shown. Substrate 2 and 3 and an electrode 4 and 5 is arranged on either side of a liquid crystal layer 6. The orientation of the liquid crystal molecules 11 is illustrated by a number of rows with small, short lines and the equipotential lines are represented by the continuous lines L stretching horizontally through the liquid crystal layer 6. FIG. 2a shows the horizontal orientation of the liquid crystal molecules 11 before switching while FIG. 2b shows the situation 20 ms after the application of a 5 V voltage difference over the liquid crystal layer 6, and the following creation of an electromagnetic field between the electrodes. Here, the molecule layer 6 is divided into domains with different tilt orientation separated with boundaries.

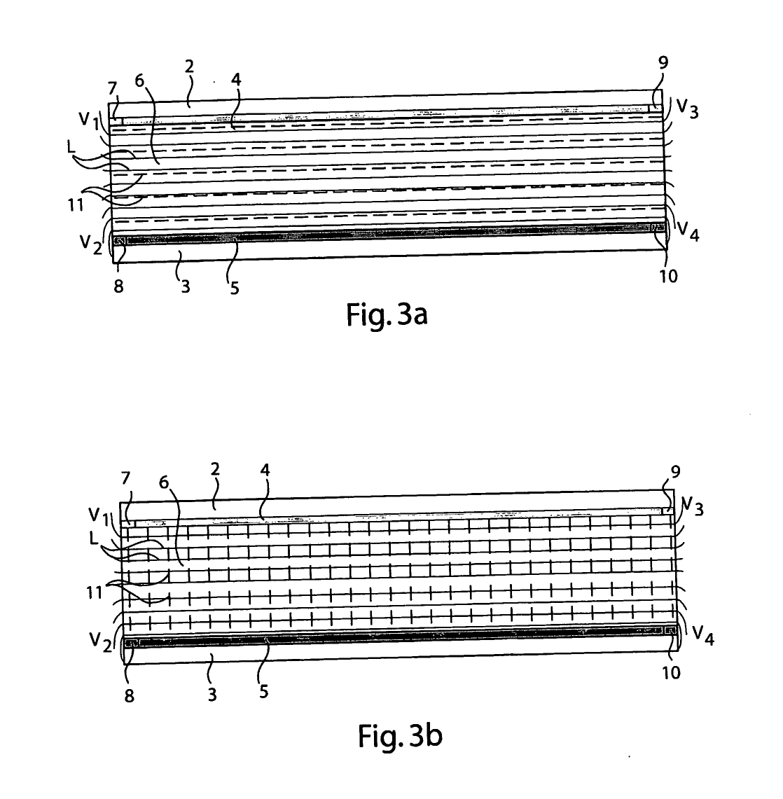

The issue can be addressed by deliberately providing the liquid crystal molecules 11 with a pretilt of a few degrees (1-2 deg) which will impede the disclinations to occur. Simulated operation of such a LCD is illustrated in FIG. 3a and 3b, where FIG. 3a shows liquid crystal molecules 11 with a pretilt value of 2 deg. (the angle is not visible to the naked eye) before switching and FIG. 3b shows how 20 ms after the application of a 5 V voltage difference over the liquid crystal layer which remains one single domain and no disclinations occur. This behavior is very much to prefer since the switching is remarkably faster and no disturbances of the disclinations deteriorates the visual performance of the LCD.

However, the creation of pretilt turns out to be very different to control. Especially for LCDs aligned by non-contact alignment techniques, such as photo alignment, it is hard to achieve a satisfactory creation of the pretilt. The present invention addresses this issue of how to avoid disclinations in zero-pretilt liquid crystal displays.

There have been several improvements of liquid crystal displays in a variety of ways over the years. An attempt to address the issue with disclinations is described in U.S. Pat. No. 5,608,556. The document describes a liquid crystal display aimed to reduce viewing angle dependency and provided with orientation control electrodes formed on either substrate and which are electromagnetically insulated from the display electrodes. Also, a potential different from that of the display electrode is applied to the orientation control electrode for controlling the orientation of the liquid crystal. When a voltage is applied to the liquid crystal layer by both the electrodes, a predetermined angle occurs between the orientation vectors of liquid crystal directors and the direction of the electromagnetic field. The device described in U.S. Pat. No. 5,608,556 does however constitute a complicated and expensive solution to the issue with disclinations involving the introduction of another electrode and the suitable switching means to control the same in coordination with the regular electrodes that creates the electromagnetic field.

A device intended to address another problem than that of the disclinations but instead to achieve an improved display picture without the jagged “staircase” effect resulting from the rectangular form of display pixels is known from WO 96/34312. The document presents a liquid crystal display provided with an electrode configuration adjacent each electrode means (pixel) which allows a non-uniform electromagnetic field to be applied across each pixel so that the optical output varies in a direction transverse to the thickness of the electro-optic layer. This allows only part of the pixel to be turned on, or for shading within the pixel. The technology applies selected voltage profiles across an array of discrete electrode means (pixels). In practice each pixel is made up of a set of conductive tracks on each side of the electro-optic layer. In order to get a varying voltage profile at each track a resistive pad to which the conductive tracks are connected is used across which the voltage ramp is applied. Hence, it is not the track on either side of the electro-optic layer that is resistive, but the connection of the track to the input electrodes.

An object of the invention is to eliminate the drawbacks mentioned above by providing an improved liquid crystal display device.

Another object of the invention is to provide an improved method for driving a liquid crystal display device in such a manner that the above mentioned drawbacks are eliminated.

These and other objects, which will appear from the following description, have now been achieved by a liquid crystal display device having the features defined in appended claim 1. Preferred embodiments are recited in the subclaims.

By applying a liquid crystal material layer exhibiting zero-pretilt and by ensuring that at least one of the electrodes is connected to at least a first and a second mutually different voltage and is adapted to exhibit a resistance between the connected voltages, the liquid crystal device can be remarkably simplified. There is no need for any extra electrodes nor for any extra switching means. The production of the LCD does neither have to involve the creation of irregular layers with display electrodes and orientation control windows alternately. Further, it is not necessary to pretilt the liquid crystal molecules, hence distinctly simplifying the manufacturing of non-contact aligned LCDs free from disclinations.

The resistive electrodes can be made of practically any material known from the prior art, as long as it is transparent enough to allow sufficient light to pass through in order to be useful in a display. Moreover, it is preferred that the material is highly resistive in order to minimize currents. The term “resisitive electrode” refers to an electrode made in such a way that two different voltages applied at the end parts of the electrode can be maintained during operation of the display. Examples of suitable materials in the resistive electrodes are transparent layers of ITO, oxygen enriched ITO, SiCrN, TaN or SnO₂. Test results have shown that sputtering an ITO layer to a thickness of 20 nm in the presence of excessive oxygen, which is followed by a heating treatment at 200° C., results in a square resistance of about 1,8 kΩ/sq. This resistance would be suitable for the invention.

Another aspect of the invention is achieved with a method having the features defined in appended claim 15. By using this method of using a liquid crystal display device, the performance of the LCD is improved, and the presence of disturbing disclinations reduced to a minimum.

The invention is applicable to all products containing liquid crystal displays, and is particularly suitable for those LCDs aligned by non-contact aligning techniques such as photo alignment, ion beam alignment and nanogroove alignment.

These and other aspects of the invention will be apparent from and elucidated with reference to the embodiments described hereinafter.

The invention will now be described in more detail with reference to the accompanying drawings which show preferred embodiments of the invention and in which:

FIG. 1 is a schematic view of the principle of operation of a conventional LCD of the prior art with two substrates each having a fully conducting electrode with a layer of liquid crystal molecules and an electromagnetic field in between,

FIG. 2a and 2b show the simulated operation with the orientation of the liquid crystal molecules in a conventional LCD of the prior art with zero-pretilt before (FIG. 2a) and after (FIG. 2b) the application of a voltage difference over the electrodes,

FIG. 3a and 3b show the simulated operation with the orientation of the liquid crystal molecules in a conventional LCD with a pretilt of 2 degrees before (FIG. 3a) and after (FIG. 3b) the application of a voltage difference over the electrodes,

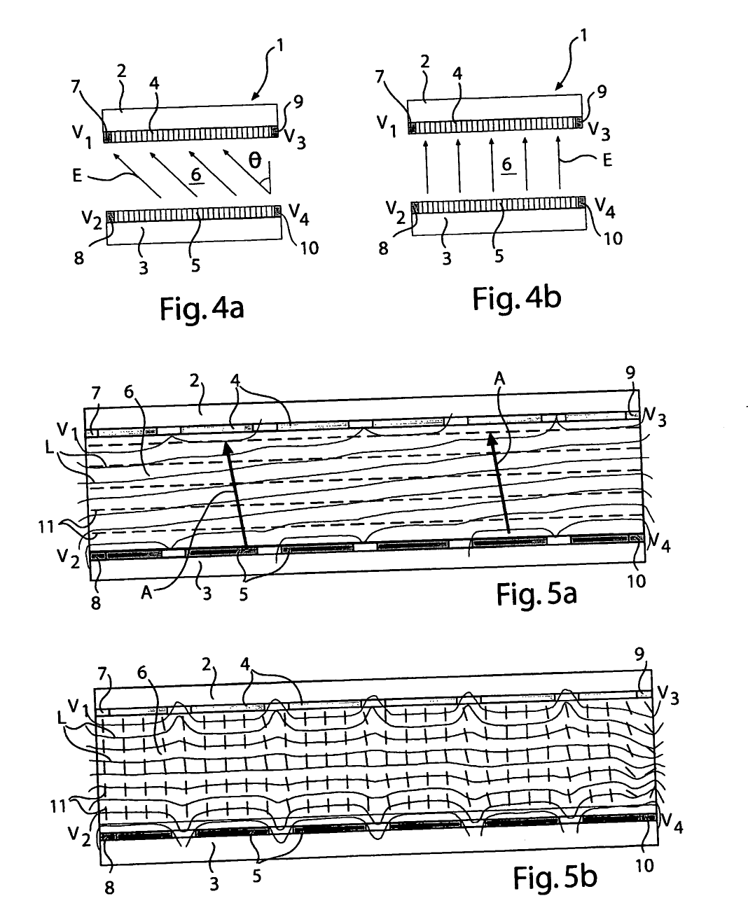

FIG. 4a and 4b show the schematic switching operation of a first embodiment of the invention with FIG. 4a showing the initially applied electromagnetic field and with FIG. 4b showing the following electromagnetic field applied in order to orient the liquid crystals perfectly perpendicular to the substrates,

FIG. 5a and 5b show the simulated operation of the embodiment of the invention according to FIG. 4a and FIG. 4b with the orientation of the liquid crystal molecules for the initially applied electromagnetic field (FIG. 5a) and for the following electromagnetic field (FIG. 5b).

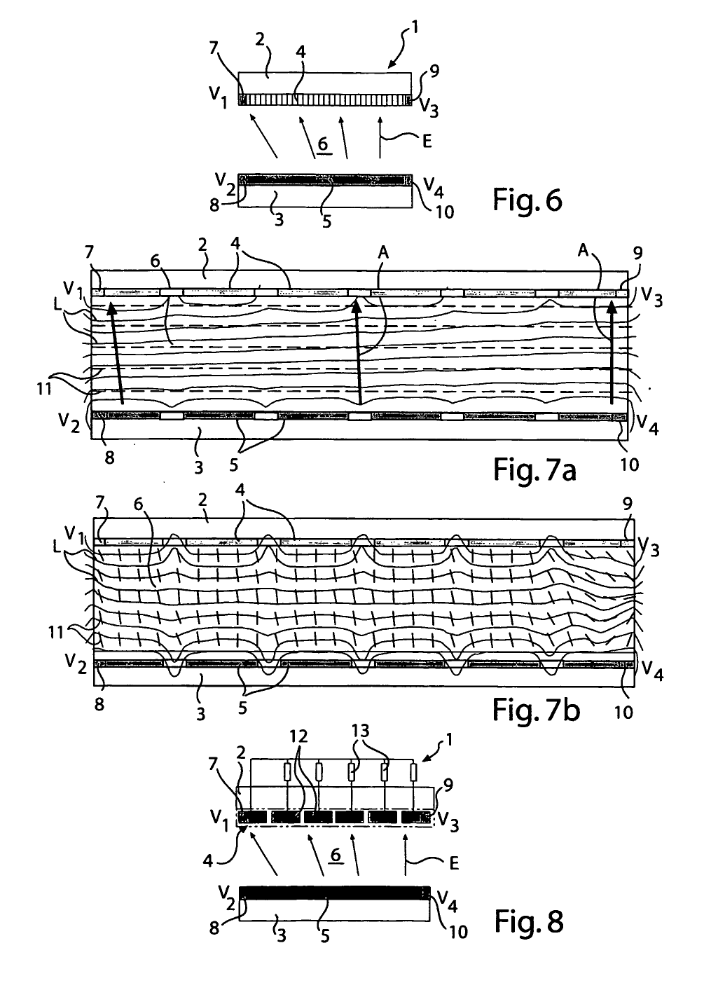

FIG. 6 is a schematic view of a second embodiment with one resistive and one fully conductive electrode and the initially applied electromagnetic field during the switching operation,

FIG. 7a and 7b show the simulated operation of the embodiment of the invention according to FIG. 6 with the orientation of the liquid crystal molecules for the initially applied electromagnetic field (FIG. 7a) and for the following electromagnetic field (FIG. 7b).

FIG. 8 is a schematic view of a third embodiment with one resistive electrode constituted by a set of conventionally conductive electrodes connected with resistors and one fully conductive electrode.

Referring now in greater detail to a preferred embodiment of the invention, FIG. 4a and 4b show the principle of operation of a liquid crystal display 1 during the switching operation with two substrates 2 and 3 each having a resistive electrode 4 and 5 and with a liquid crystal material layer 6 and a generated electromagnetic field E thereinbetween.

The voltages V₁, V₂, V₃ and V₄ are applied to the end parts 7, 8, 9 and 10 of the electrodes 4 and 5. In FIG. 4a, there is a potential drop between the right end parts 9 and 10 and the left end parts 7 and 8 for the electrodes 4 and 5. Since the electrodes 4 and 5 are resistive, the potential increases monotonically from V₁ to V₃, for the lower electrode 5 and from V₂ to V₄ for the upper electrode 4. This results in a an obliquely oriented and homogeneous electromagnetic field E. The situation becomes different in FIG. 4b after changing the adjustable voltages, when the same voltage (V₁=V₃) is applied to both end parts 7 and 9 of the upper electrode 4 as is the same voltage (V₂=V₄) applied to both end parts 8 and 10 of the lower electrode 5. This means that all locations on each electrode 4 and 5 have the same potential and that the electromagnetic field E is vertical and homogeneous.

By choosing the value of the voltages, one can set the angle θ of the electromagnetic field E to any value. In general, a small angle θ (approximately 2 deg.) is obtained for a correspondingly small voltage difference between the left end parts 7 and 8 and the right end parts 9 and 10 of the electrodes 4 and 5.

It should be noted that the LCD device 1 in itself is not modified in FIG. 4b in comparison to that of FIG. 4a The arrangement with the connections and the resisting electrodes 4 and 5 are the same, the only thing that has changed is the application of the voltages in such a way that a potential drop is achieved between the end parts 7, 8, 9 and 10 of the electrodes 4 and 5.

Successful test results have given a number of examplifying voltages during the switching operation for the application of the invention in FIG. 4a and 4b. In FIG. 4a in the upper electrode 4 at the left end part 7 the voltage V₁ is 0 V and at the right end part 9 the voltage V₃ is 1,25 V while in the lower electrode 5 at the left end part 8 the voltage V₂ is 3,75 V and at the right end part 10 the voltage V₄ is 5 V.

For the situation in FIG. 4b is the voltage V₁=V₃=0 V in the upper electrode and the voltage V₂=V₄=5 V in the lower electrode.

The operation of this embodiment of the invention is illustrated in simulations showed in FIG. 5a and 5b. All simulations have been carried out with a cell thickness of 5 μm, a cell width of 46 μm and with Merck ZLI-4792 as liquid crystal material. In these figures are the electrodes 4 and 5 for simulation purposes illustrated as discrete conductive electrode elements connected to different voltages, but should however be regarded as two continuous, resistive electrodes 4 and 5. The first figure, FIG. 5a, shows the initial situation of the switching operation with the arrows A and the continuous lines L indicating the obliqueness of the electromagnetic field and the orientation of individual crystal molecules 11. Both upper and lower electrodes 4 and 5 now exhibit potential drops. FIG. 5b shows the situation 20 ms later, after the application of the same voltages to both end parts 7, 8, 9 and 10 of each electrode 4 and 5, and consequently, the establishment of a conventional perpendicular electromagnetic field. No disclinations appear during the reorientation of the liquid crystal molecules or after the voltage adjustment, but all LC molecules are almost perpendicular to the normal of the electrodes. Small, local disorientations of the liquid crystal molecules 11 are an artifact of the simulation due to discretization of the resistive electrodes 4 and 5. These disorientations are absent in a real liquid crystal display 1, utilizing the invention.

In another embodiment of the invention, illustrated in FIG. 6, only the upper electrode 4 exhibits resistance and a potential drop between two different voltages V₁ and V₃, while the lower electrode 5 is fully conductive. The result is a gradient in orientation of the electromagnetic field E.

The magnitude of the gradient in orientation depends on the voltage difference between the left end parts 7 and 8 of the electrodes 4 and 5, and the right end parts 9 and 10 of the electrodes 4 and 5. The effect is similar as with the angle θ, representing the fall of the electromagnetic field E in the case with two resistive electrodes 4 and 5 described above. This latter embodiment has the advantage of only needing one substrate 2 with a resistive electrode 4, while the other substrate 3 may have a conventional, fully conducting electrode 5.

The simulated operation of this embodiment is illustrated in FIG. 7a and 7b. In a first sequence, the arrows A and the horizontal continuous lines L indicated in FIG. 7a shows the gradient orientation of the initial electromagnetic field. It is then distinctly oblique at the far left side, gradually becoming less oblique from left to right. It can also be seen how the elastic behavior of the liquid ensures that the orientation of the liquid crystal molecules 11 at the left side is transferred to the liquid crystal molecules 11 at the right side. FIG. 7b shows the LCD 20 ms after the switching and the application of voltages of the same size to both end parts 7, 8, 9 and 10 of each electrode 4 and 5, the establishment of a conventional perpendicular electromagnetic field. Small local disorientation of the liquid crystal molecules 11 is again an artifact due to the discretization of the resistive electrode 4 .

In still another embodiment of the invention, illustrated in FIG. 8, the same principle is applied as in the above described case with a gradient orientation of the electromagnetic field E. However, the resistive electrode 4 is not continually resistive, but made up of a set of conductive electrode elements 12 each connected to a resistor 13, resulting in a discrete potential drop between the connected voltages of the end parts 7 and 9 of the electrode 4. The electromagnetic field E correspondingly exhibits a discrete gradient in orientation.

Finally, it should be pointed out that the inventive concept by no means is restricted to the embodiments described herein, but several modifications are feasible within the scope of the appended claims. For example it is possible to arrange a LCD 1 with both substrates 2 and 3 having resistive electrodes 4 and 5 made up of a set of conventional conducting electrode elements 12 each connected with a resistor 13.

1. A liquid crystal display device for avoiding disclinations comprising a first and a second substrate said first and second substrates being located facing one another with a liquid crystal material layer thereinbetween, a first and a second electrode arranged at said first and second substrates respectively, said first and second electrodes being formed on the liquid crystal side of the said first and second substrates whereby the liquid crystal material layer Exhibits zero-pretilt and at least one of the electrodes at its end parts is connected to at least a first and a second mutually different and adjustable voltage and is adapted to exhibit an essential resistance between the end parts.

2. A liquid crystal display device according to claim 1, wherein at least one of the electrodes is adapted to exhibit such a resistance between the end parts that a voltage difference is maintainable during the operation of said liquid crystal display device.

3. A liquid crystal display device according to claim 1, wherein the electrodes are arranged to at use generate an electromagnetic field that is obliquely angled relatively to the normals of said electrodes.

4. A liquid crystal display device according to claim 1, above, wherein at least one of the electrodes is made of a resistive material such that a voltage difference between the end parts of said electrode is maintainable during the operation of said liquid crystal display device.

5. A liquid crystal display device according to claim 1, wherein both electrodes are adapted to exhibit such a resistance between the end parts of said electrode such that a voltage difference is maintainable during the operation of said liquid crystal display device.

6. A liquid crystal display device according to claim 1, wherein only one of the electrodes is adapted to exhibit such a resistance between the end parts of said electrode such that a voltage difference is maintainable during the operation of said liquid crystal display device.

7. A liquid crystal display device according to claim 1, wherein at least one of the electrodes exhibits a potential drop between connected voltages at the end parts.

8. A liquid crystal display device according to claim 1, above, wherein at least one of the electrodes comprises a set of electrode segments which each is separately connected to a resistor.

9. A liquid crystal display device according to claim 1, above, wherein the liquid crystal display device has been aligned by non-contact alignment techniques.

10. A liquid crystal display device according to claim 4, wherein the resistive material is ITO.

11. A liquid crystal display device according to claim 4, wherein the resistive material is oxygen enriched ITO.

12. A liquid crystal display device according to claim 4, wherein the resistive material is SiCrN.

13. A liquid crystal display device according to claim 4, wherein the resistive material is TaN.

14. A liquid crystal display device according to claim 4, wherein the resistive material is SnO₂.

15. A method for driving a liquid crystal display device comprising the step of changing the direction of the applied electric field during switching of the liquid crystal molecules.

16. A method for driving a liquid crystal display device according to claim 15, comprising the steps of
providing at least two electrodes wherein at least one of said electrodes exhibits a resistance between its end parts,
connecting at least a first and a second mutually different and adjustable voltage to at least one of said electrodes,
applying subsequently first an oblique electromagnetic field between said electrodes, and then at a later moment in time,
applying an orthogonal electromagnetic field between said electrodes.

17. A method for driving a liquid crystal display device according to claim 15, wherein the characteristics of the electromagnetic field controlled by the voltages connected to said end parts of the electrodes.
